(19) United States
(12) Patent Application Publication
(10) Pub. No.: US 2026/0219098 A1
(43) Pub. Date: Jul. 30, 2026

(54) LOAD CELL HAVING TRANSPORT ANTI-DROP MECHANISM, AND ELECTRONIC BALANCE COMPRISING SAME

(71) Applicant: Mettler-Toledo Instruments (Shanghai) Co., Ltd., Shanghai (CN)

(72) Inventors: Peng Huang, Shanghai (CN); Chao Wu, Shanghai (CN)

(21) Appl. No.: 19/146,762

(22) PCT Filed: Jan. 10, 2024
(86) PCT No.: PCT/CN2024/071609

§ 371 Date: Jul. 9, 2025

(30) Foreign Application Priority Data
Jan. 12, 2023 (CN) 202310066011.9

(51) Int. Cl. G01G 23/00; G01G 21/23

(52) U.S. Cl. CPC G01G 23/005; G01G 21/23

(57) ABSTRACT

These disclosures provide a load cell having a transport anti-drop mechanism and an electronic balance including the load cell. The load cell includes a base, a core shaft, an elastic body, a sleeve, a limit pin, a weighing pan support, and a weighing pan connector. The base is provided with a mounting recess, the weighing pan support is provided with a through hole, and the sleeve passes through the through hole and extends into the mounting recess. The core shaft is arranged in the sleeve in a penetrating manner, the elastic body is mounted between the core shaft and the sleeve, the weighing pan connector is mounted at an end portion of the core shaft, the limit pin is mounted at the end of the core shaft and located outside the sleeve, the end of the sleeve is provided with a plurality of limit notches, and a limit baffle is provided on an inner wall surface of the mounting recess. The load cell can be switched between a non-transport protection state, an overload protection state, and a transport protection state, which improves the drop impact resistance during transport, and the force applied to delicate parts is controlled by the amount of compression of the elastic body and it will not exceed the yield strength of the delicate parts.

### BACKGROUND OF THE INVENTION

### Technical Field

The present invention relates to the field of load cells, and in particular to a load cell having a transport anti-drop mechanism and an electronic balance comprising said load cell.

### Background Art

Existing electronic balances can easily be damaged by drop impact during transportation, especially the high-precision electronic balances using a magnetic force restoration load cell. Scales or electronic balances can be damaged not only while transportation from the manufacturer to the buyer but also during transport and cleaning within the premises of the user due to accidental drops.

Also, accidental drop of the electronic balance during operation or application of an unbalanced load or excessive load on the weighing pan of the electronic balance, beyond its the operating capacity can lead to damage of the load cell and its functioning.

In the patent document CN 202123259807 U, a suction assembly is provided to suck an electronic balance onto a platform to avoid damage caused by collision or drop, but this method does not work during transport.

In the patent document CN 200720071516 U, a Z-shaped plate is pressed by means of a screw to prevent a load cell from being damaged during transport. The load cell in this patent is a strain gauge load cell. Due to the different structure and working principle of the magnetic force restoration load cell, the method of pressing the Z-shaped plate with a screw may damage the weak and sensitive part (flexible joints) in the load cell. This method is not suitable for the magnetic force restoration load cell, and also requires additional fasteners and parts such as the Z-shaped plate.

In the patent document CN 207798246 U, a load cell assembly is provided with a floating overload protection structure that can be disengaged under the impact when placed upside down to reduce the impact on the load cell but cannot reduce the impact when placed facing up.

Therefore, it is necessary to improve the impact resistance of the high-precision electronic balance that uses a magnetic force restoration load cell to avoid the damage when dropped during transport or in case of overloading of an electronic balance.

In order to overcome the aforementioned technical problems, the applicant's inventors have designed a load cell having a transport anti-drop mechanism and an electronic balance comprising said load cell.

### SUMMARY

The technical problem to be solved by the present invention is to provide a load cell having a transport anti-drop mechanism, and an electronic balance comprising said load cell, in order to overcome the defects in the prior art of load cell being prone to impact and damage.

The present invention solves the above technical problems by a load cell having a transport anti-drop mechanism comprising a base, a core shaft, an elastic body, a sleeve, a limit pin, a weighing pan support, and a weighing pan connector, wherein the base is provided with a mounting recess, the weighing pan support is provided with a through hole, and the sleeve passes through the through hole and extends into the mounting recess; the core shaft is arranged in the sleeve in a penetrating manner, the elastic body is mounted between the core shaft and the sleeve, the weighing pan connector is mounted at an end portion of the core shaft, the limit pin is mounted at the end of the core shaft and located outside the sleeve, the end of the sleeve is provided with a plurality of limit notches, characterized by a limit baffle provided on an inner wall surface of the mounting recess for limiting the position of upward movement of the limit pin; the load cell is capable of switching between a non-transport protection state, an overload protection state and a transport protection state through the fitting between the limit pin and the corresponding limit notch and the limit baffle.

Load cell comprising a moving part having predetermined position; when the weighing pan connector receives a downward force that exceeds a pre-compression force of the elastic body, the load cell is in an overload protection state; wherein the limit pin moves downwards and is disengaged from the corresponding limit notch and in contact with the base, and the base bears the load that exceeds the compression force of the elastic body, so that the position of a moving part of the load cell is fixed;

When the load cell is in a transport protection state, wherein the limit pin comes into contact with the limit baffle to limit the position of the limit pin to allow the limit pin to enter the corresponding limit notch, and the elastic body applies a fixed load to the moving part of the load cell to fix the position of the moving part.

According to an embodiment of the present invention, the moving part comprises delicate parts such as the lever 110, the upper connection joint 140, the lower connection joint 150 and the flexible joint 160.

According to an embodiment of the present invention, the limit baffle horizontally extends outwards along the inner wall surface and is located above the limit pin.

According to an embodiment of the present invention, the limit notch is a U-shaped notch.

According to an embodiment of the present invention, the end of the sleeve is provided with four symmetrically distributed U-shaped notches.

According to an embodiment of the present invention, the U-shaped notches include at least one pair of first U-shaped notches and at least one pair of second U-shaped notches arranged opposite each other; when the moving part of the load cell is movable, the limit pin is located in the first U-shaped notches and has a distance from the base; and when the load cell is in a transport protection state, the limit pin is located in the second U-shaped notches, and the limit pin has a distance from the bottom of the second U-shaped notches.

According to an embodiment of the present invention, a first rotation baffle is further provided on the inner wall surface of the mounting recess for limiting the rotation angle of the core shaft when the load cell is switched from the overload protection state to the transport protection state.

According to an embodiment of the present invention, a second rotation baffle is further provided on the inner wall surface of the mounting recess for limiting the rotation angle of the core shaft when the load cell is switched from the transport protection state to the non-transport protection state.

According to an embodiment of the present invention, the first rotation baffle and the second rotation baffle are vertically connected below the limit baffle.

The present invention further provides a load cell having a transport anti-drop mechanism, characterized in that the load cell comprises a base, a core shaft, an elastic body, a sleeve, and a weighing pan support, wherein the base is provided with a mounting recess, the weighing pan support is provided with a through hole, and the sleeve passes through the through hole and extends into the mounting recess; the core shaft is arranged in the sleeve in a penetrating manner, the elastic body is mounted between the core shaft and the sleeve, a shaft end of the core shaft is provided with an externally threaded connecting member, and the bottom of the mounting recess is provided with an internally threaded hole; and the core shaft is fixedly connected to the base by means of the fitting between the externally threaded connecting member and the internally threaded hole, and the elastic body applies a fixed load to a moving part of the load cell to fix the position of the moving part.

The present invention further provides an electronic balance, characterized in that the electronic balance comprises the load cell having a transport anti-drop mechanism as described above.

The present invention has a positive improvement that, a structure for improving the impact resistance of the magnetic force restoration load cell is designed to allow the load cell to be switched between the non-transport protection state, the overload protection state and the transport protection state, and the load that exceeds the compression force of the elastic body can be directly transferred to the base, thereby protecting the delicate parts against collision impact.

The drop impact resistance during transportation and in case of overloading can be improved by using such a structure, as the force applied to the delicate parts is controlled by the amount of compression of the elastic body, and it will not exceed the yield strength of the delicate parts.

### BRIEF DESCRIPTION OF THE DRAWINGS

The above and other features, properties and advantages of the present invention will become more apparent from the description below in conjunction with the accompanying drawings and embodiments, and the same features are always indicated by the same reference numerals in the figures, in which:

FIG. 1A is a schematic diagram showing an electronic balance comprising the load cell according to the present invention.

FIG. 1B is a perspective view of a load cell having a transport anti-drop mechanism according to the present invention.

FIG. 2 is a schematic structural diagram of a first embodiment of the load cell having a transport anti-drop mechanism according to the present invention.

FIG. 3 is an enlarged view of part A in FIG. 2.

FIG. 4 is a schematic diagram showing the internal structure of the first embodiment of the load cell having a transport anti-drop mechanism according to the present invention when in a non-transport protection state.

FIG. 5 is a sectional view taken along line B-B in FIG. 4.

FIG. 6 is a schematic diagram viewed along direction C in FIG. 4.

FIG. 7 is a schematic diagram showing the internal structure of a mounting recess in the first embodiment of the load cell having a transport anti-drop mechanism according to the present invention.

FIG. 8 is a schematic plan view of part D in FIG. 7.

FIG. 9 is a sectional view taken along line E-E in FIG. 8.

FIG. 10 is a schematic diagram showing the assembly of a core shaft, a sleeve and a limit pin of the first embodiment of the load cell having a transport anti-drop mechanism according to the present invention when in the non-transport protection state.

FIG. 11 is an enlarged view of part F in FIG. 10.

FIG. 12 is a schematic diagram showing the principle of the first embodiment of the load cell having a transport anti-drop mechanism according to the present invention when in the non-transport protection state.

FIG. 13 is a schematic diagram showing the internal structure of the first embodiment of the load cell having a transport anti-drop mechanism according to the present invention when in an overload protection state.

FIG. 14 is a sectional view taken along line G-G in FIG. 13.

FIG. 15 is a schematic diagram viewed along direction H in FIG. 13.

FIG. 16 is a schematic diagram showing the assembly of the core shaft, the sleeve and the limit pin of the first embodiment of the load cell having a transport anti-drop mechanism according to the present invention when in the overload protection state.

FIG. 17 is an enlarged view of part I in FIG. 16.

FIG. 18 is a schematic diagram showing the principle of the first embodiment of the load cell having a transport anti-drop mechanism according to the present invention when in the overload protection state.

FIG. 19 is a schematic diagram showing the assembly of the core shaft, the sleeve and the limit pin of the first embodiment of the load cell having a transport anti-drop mechanism according to the present invention when switched from the overload protection state to a transport protection state.

FIG. 20 is an enlarged view of part J of FIG. 19.

FIG. 21 is a schematic diagram showing the internal structure of the first embodiment of the load cell having a transport anti-drop mechanism according to the present invention when in the transport protection state.

FIG. 22 is a sectional view taken along line K-K in FIG. 21.

FIG. 23 is a schematic diagram viewed along direction L in FIG. 21.

FIG. 24 is a schematic diagram showing the assembly of the core shaft, the sleeve and the limit pin of the first embodiment of the load cell having a transport anti-drop mechanism according to the present invention when in the transport protection state.

FIG. 25 is an enlarged view of part M in FIG. 24.

FIG. 26 is a schematic diagram showing the principle of the first embodiment of the load cell having a transport anti-drop mechanism according to the present invention when in the transport protection state.

FIG. 27 is a schematic diagram showing the principle of a second embodiment of the load cell having a transport anti-drop mechanism according to the present invention.

### DESCRIPTION OF EMBODIMENTS

In order to make the above objectives, features and advantages of the present invention more apparent and easier to understand, the particular embodiments of the present invention will be described in detail below in conjunction with the accompanying drawings.

The embodiments of the present invention will now be described in detail with reference to the accompanying drawings. Reference will now be made in detail to the preferred embodiments of the present invention, examples of which are illustrated in the accompanying drawings. The same reference numerals used in all the accompanying drawings denote identical or similar parts wherever possible.

Furthermore, although the terms used in the present invention are selected from well-known common terms, some of the terms mentioned in the description of the present invention may have been selected by the applicant according to his or her determination, and the detailed meaning thereof is described in the relevant section described herein.

Furthermore, the present invention must be understood, not simply by the actual terms used but also by the meanings encompassed by each term.

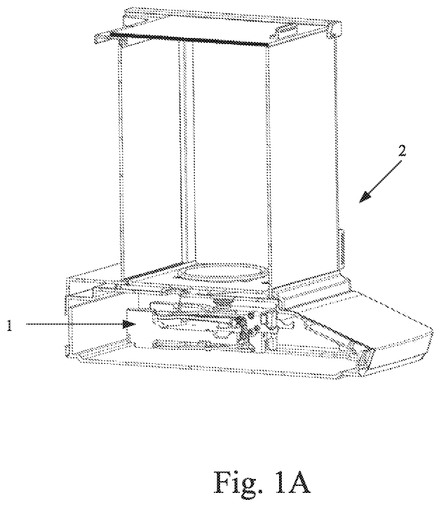

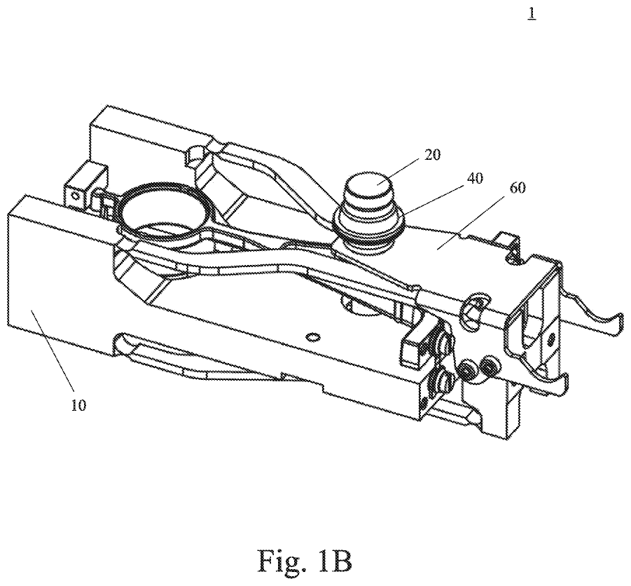

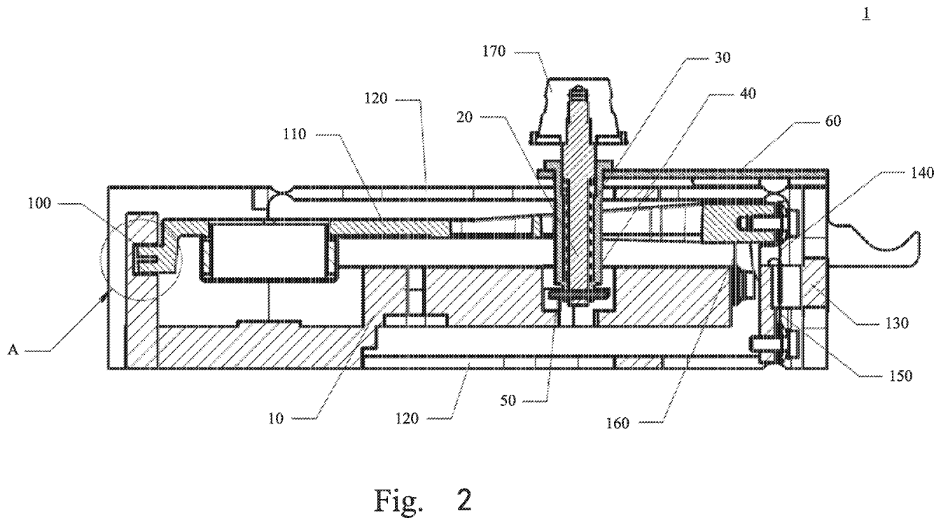

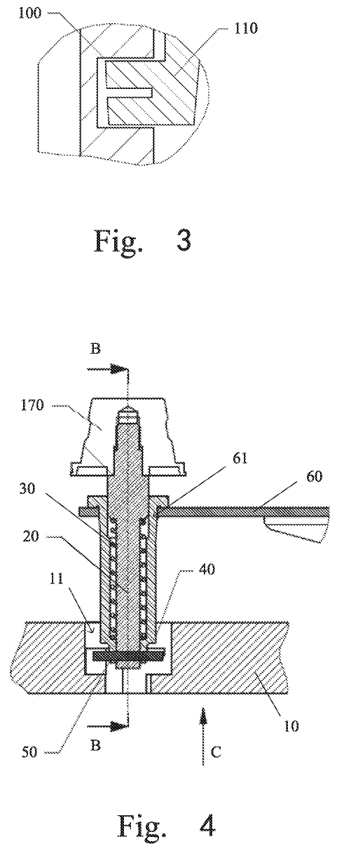

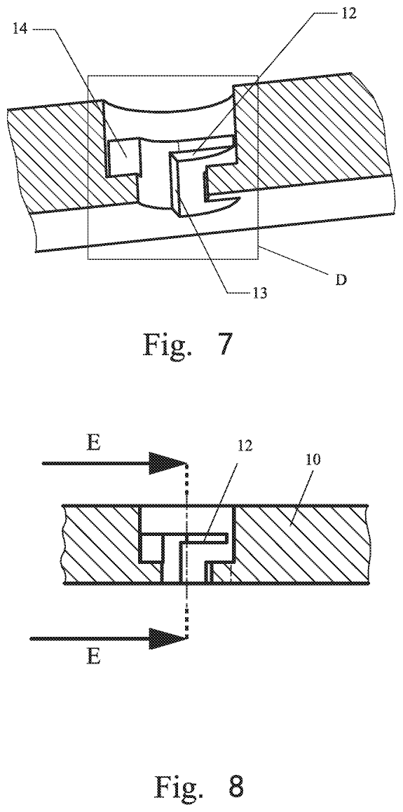

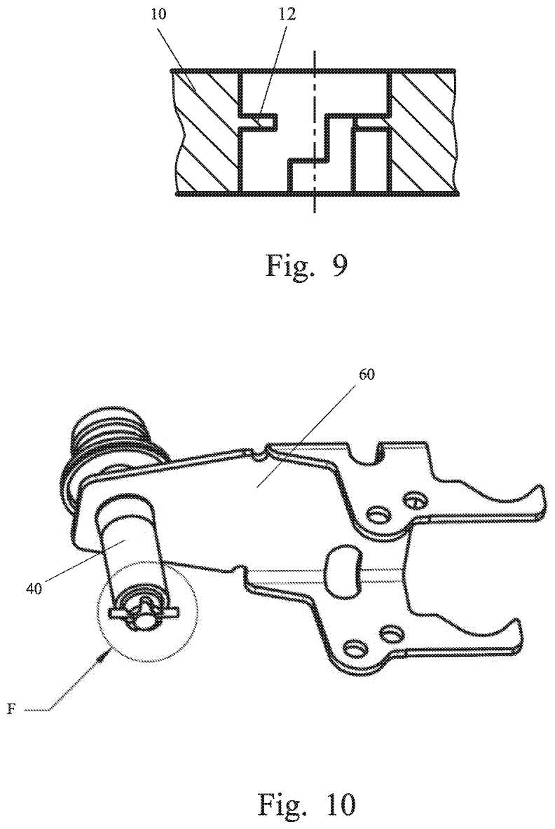

As shown in FIGS. 1A to 12, the first embodiment of present invention discloses a load cell 1 having a transport anti-drop mechanism, the load cell 1 comprising a base 10, a core shaft 20, an elastic body 30, a sleeve 40, a limit pin 50, a weighing pan support 60, and a weighing pan connector 170. The load cell 1 further comprises a lever limit notch 100, a lever 110, a parallel guide sheet 120, a lifting lug 130, an upper connection joint 140, a lower connection joint 150, and a flexible joint 160.

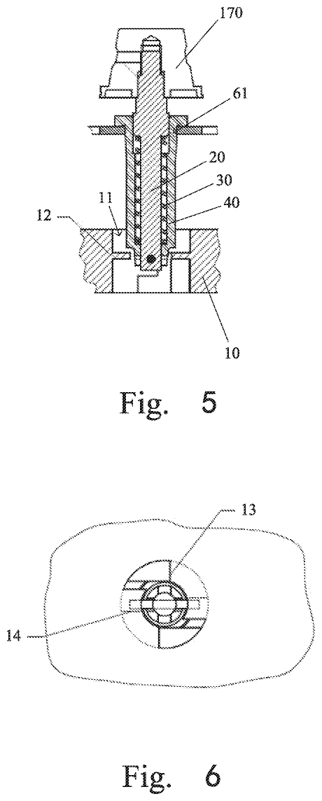

The base 10 as shown in FIG. 5 is provided with a mounting recess 11, the weighing pan support 60 is provided with a through hole 61, and the sleeve 40 passes through the through hole 61 and extends into the mounting recess 11. The core shaft 20 is arranged in the sleeve 40 in a penetrating manner, the elastic body 30 (preferably a spring) is mounted between the core shaft 20 and the sleeve 40, and the weighing pan connector 170 is mounted at the top end of the core shaft 20. The limit pin 50 is mounted at the end of the core shaft 20 and located outside the sleeve 40, and the end of the sleeve 40 is provided with a plurality of limit notches 41. A limit baffle 12 is provided on an inner wall surface of the mounting recess 11 for limiting the position of upward movement of the limit pin 50.

When the weighing pan connector 170 receives a downward force that exceeds a pre-compression force of the elastic body 30, the load cell 1 is in an overload protection state, the limit pin 50 moves downwards and is disengaged from the corresponding limit notch 41 and in contact with the base 10, and the base 10 bears the load that exceeds the compression force of the elastic body 30, so that the position of a moving part of the load cell 1 is fixed.

When the load cell (1) is in a transport protection state, the limit pin 50 comes into contact with the limit baffle 12 to limit the position of the limit pin 50 to allow the limit pin 50 to enter the corresponding limit notch 41, and the elastic body 30 applies a fixed load to the moving part of the load cell 1 to fix the position of the moving part.

The moving part comprises delicate parts such as the lever 110, the upper connection joint 140, the lower connection joint 150 and the flexible joint 160, and the weighing pan support 60 sequentially drives the lower connection joint 150, the upper connection joint 140, the lower connection joint 150, the flexible joint 160 and the lever 110 to rotate the lever 110 to press against the upper portion of the lever limit notch 100.

The limit notch 41 may be preferably a U-shaped notch. For example, preferably, the end of the sleeve 40 may be provided with four symmetrically distributed U-shaped notches.

The load cell 1 is switched between a non-transport protection state, an overload protection state and a transport protection state through the fitting between the limit pin 50, the corresponding limit notch 41 and the limit baffle 12. The non-transport protection state means that the moving part of the load cell 1 is not fixed and the load cell 1 is in a process of not being transported. The overload protection state means that when the load born by the weighing pan connector 170 of the load cell 1 exceeds the pre-compression force of the elastic body 30, an overload protection structure (comprising the core shaft 20, the elastic body 30, the sleeve 40, the limit pin 50, etc.) is triggered to transfer the load that exceeds the compression force of the elastic body 30 to the base 10. The transport protection state means that during transport of the load cell 1, the load on the weighing pan connector 170 is removed and a transport protection structure (comprising the core shaft 20, the elastic body 30, the sleeve 40, the limit pin 50, etc.) applies a fixed load to the moving part by means of controlling the amount of compression of the elastic body (e.g., a spring) to fix the position of the moving part.

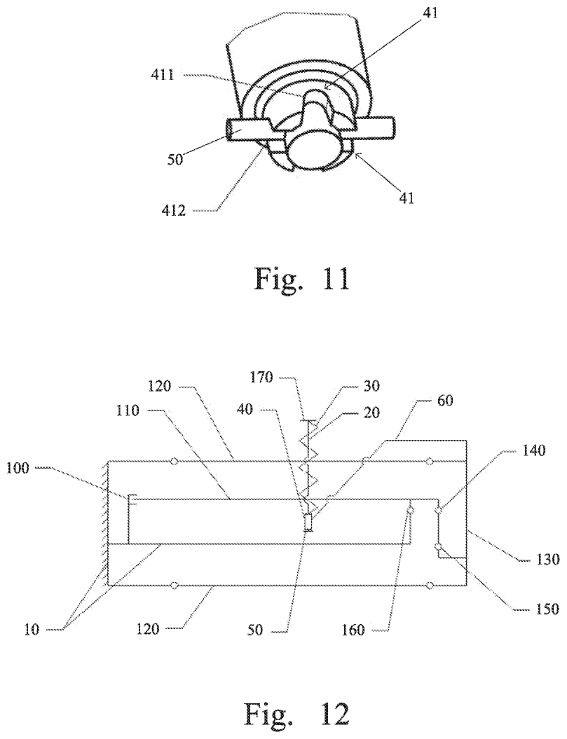

For example, as shown in FIG. 11, the U-shaped notches may preferably include at least one pair of first U-shaped notches 411 and at least one pair of second U-shaped notches 412 arranged opposite each other.

When the moving part of the load cell 1 can move, the limit pin 50 is located within the first U-shaped notches 411 and has a distance from the base 10. When the load cell 1 is in a transport protection state, the limit pin 50 is located in the second U-shaped notches 412, and the limit pin 50 has a distance from the bottom of the second U-shaped notches 412.

Further, the limit baffle 12 horizontally extends outwards along the inner wall surface of the mounting recess 11 and is located above the limit pin 50.

Still further, a first rotation baffle 13 is further provided on the inner wall surface of the mounting recess 11 for limiting the rotation angle of the core shaft 20 when the load cell 1 is switched from the overload protection state to the transport protection state.

In addition, further preferably, a second rotation baffle 14 is further provided on the inner wall surface of the mounting recess 11 for limiting the rotation angle of the core shaft 20 when the load cell 1 is switched from the transport protection state to the non-transport protection state.

Preferably, the first rotation baffle 13 and the second rotation baffle 14 are vertically connected below the limit baffle 12.

As shown in FIGS. 4 to 12, the load cell 1 having a transport anti-drop mechanism is in a non-transport protection state, hereinafter referred to as state 1. In the magnetic force restoration load cell mechanism in state 1, the lever 110 has freedom of rotation and the lever 110 can be rotated within a limit range of the lever limit notch 100.

Accordingly, the lifting lug 130, the weighing pan support 60, the elastic body 30, the core shaft 20, the sleeve 40 and the weighing pan connector 170 are all movable within a certain range. If the load cell 1 is in this state during transport, the moving part will move and collide with the lever limit notch 100 to create an impact load. The delicate parts, such as the upper connection joint 140, the lower connection joint 150 and the flexible joint 160, may deform or fracture when the impact load that exceeds their yield strength, thus affecting the performance of the load cell 1 or making the load cell completely disable.

In state 1, the limit pin 50 is pressed upwards against the sleeve 40, the sleeve 40 is provided with the first U-shaped notches 411, and the limit pin 50 is located in the first U-shaped notches 411 to limit the rotation of the limit pin 50 and the core shaft 20 in this state. There is no contact between the limit pin 50 and the base 10.

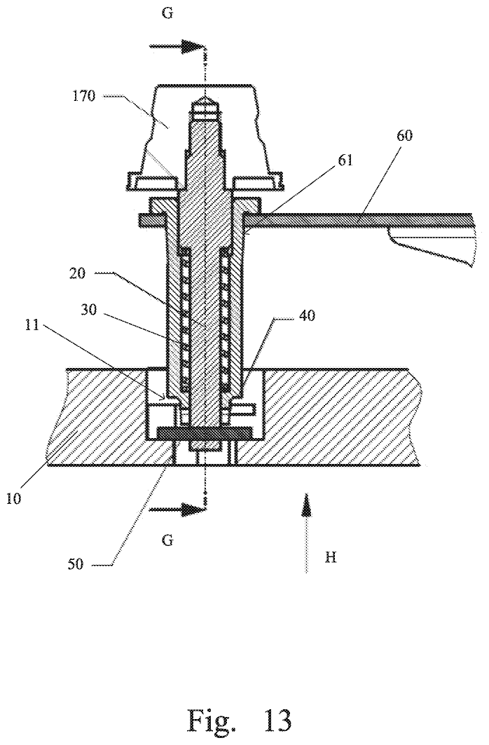

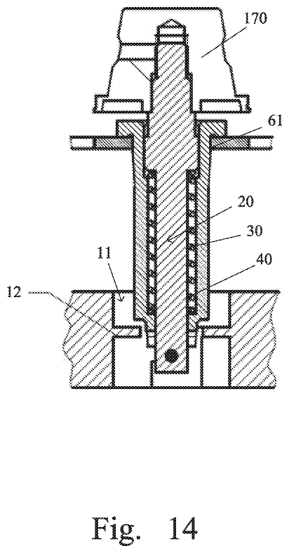

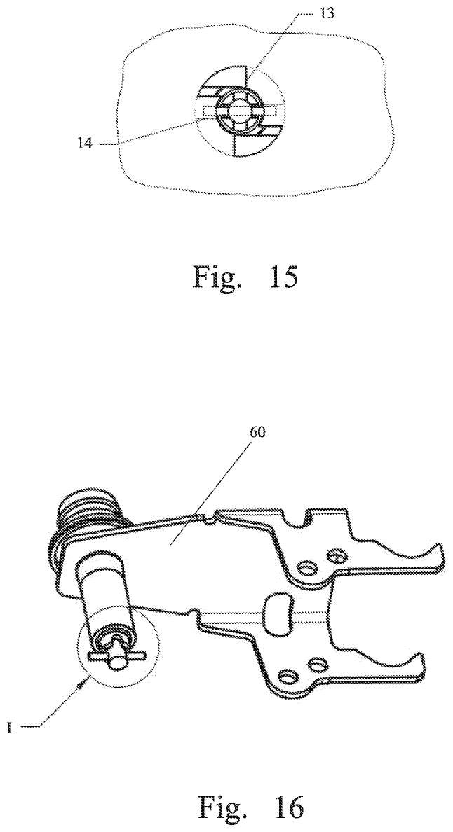

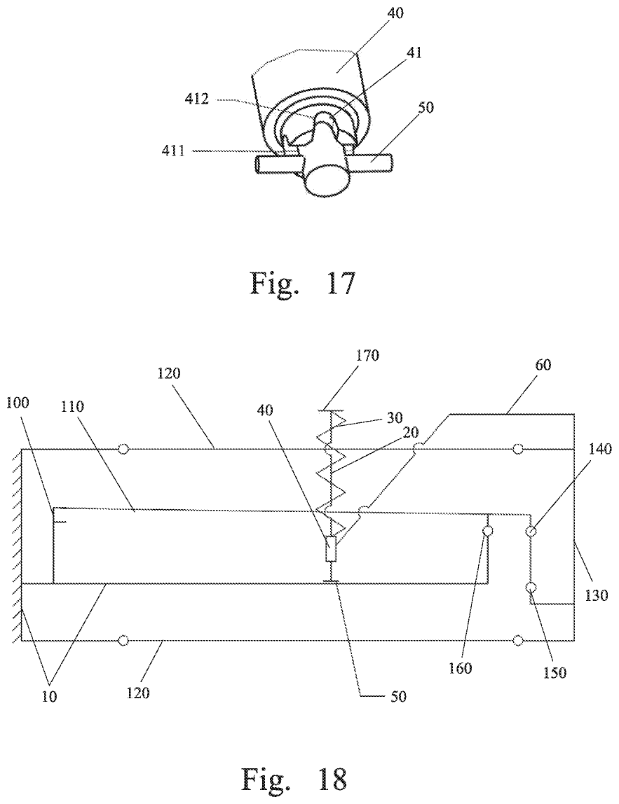

As shown in FIGS. 13 to 18, the load cell 1 having a transport anti-drop mechanism is in a triggered overload protection state, hereinafter referred to as state 2. The working principle of the overload protection structure is as follows. The sleeve 40 and the core shaft 20 form a sliding pair. The upper end of the core shaft 20 is rigidly connected to the weighing pan connector 170 for bearing the gravity of a weighed item on the electronic balance 2. The lower end of the core shaft 20 is rigidly connected to the limit pin 50. The elastic body 30 has an upper end lying against the core shaft 20 and a lower end lying against the sleeve 40, and the elastic body has a pre-compression force. When the downward load on the weighing pan connector 170 exceeds the pre-compression force of the elastic body (30), the weighing pan connector 170, the core shaft 20, and the limit pin 50 move downwards until the limit pin 50 comes into contact with the base 10 of the load cell 1. In this case, the load that exceeds the compression force of the elastic body (30) can be directly transferred to the base 10, thereby protecting the delicate parts such as the upper connection joint 140, the lower connection joint 150 and the flexible joint 160.

In state 2, the weighing pan connector 170 bears the downward force that exceeds the pre-compression force of the elastic body, and the core shaft 20 and limit pin 50 move downwards. The limit pin 50 is disengaged from the first U-shaped notches 411 of the sleeve 40 and comes into contact with the base 10 to bear the load that exceeds the compression force of the elastic body 30. In FIG. 16, “I” shows position of the limit pin 50 with respect to first U-shaped notches 411 of the sleeve 40.

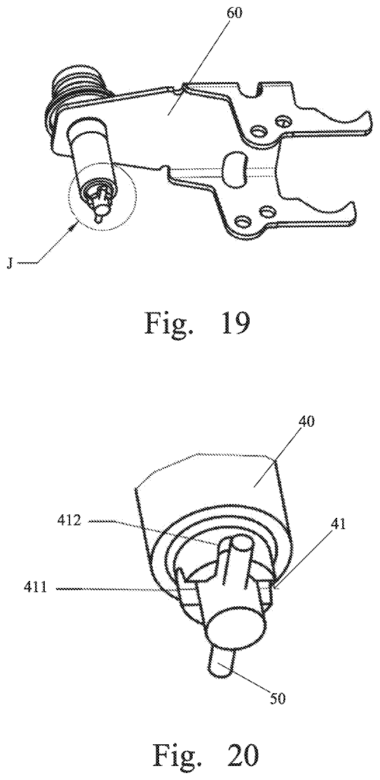

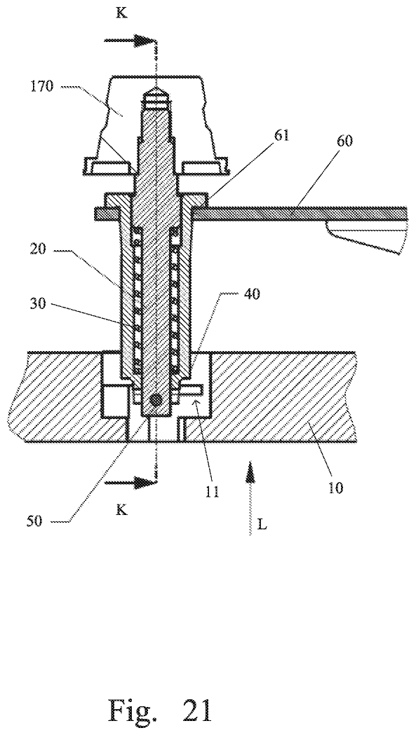

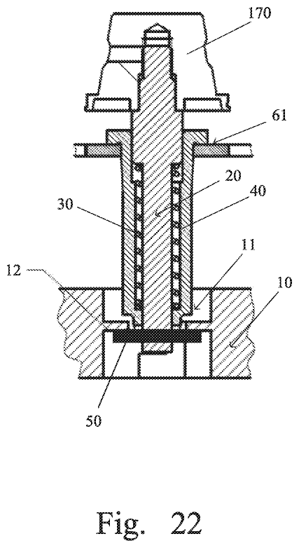

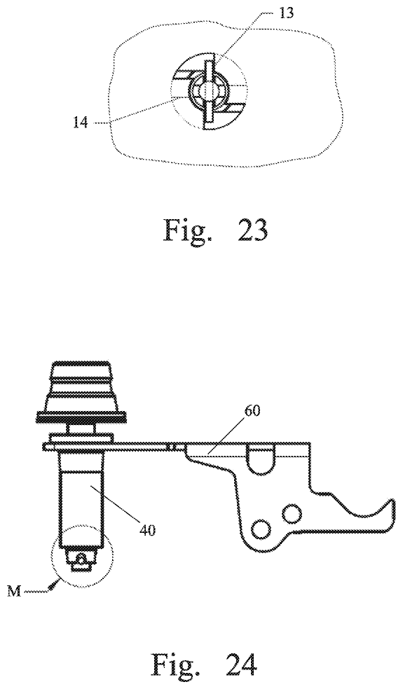

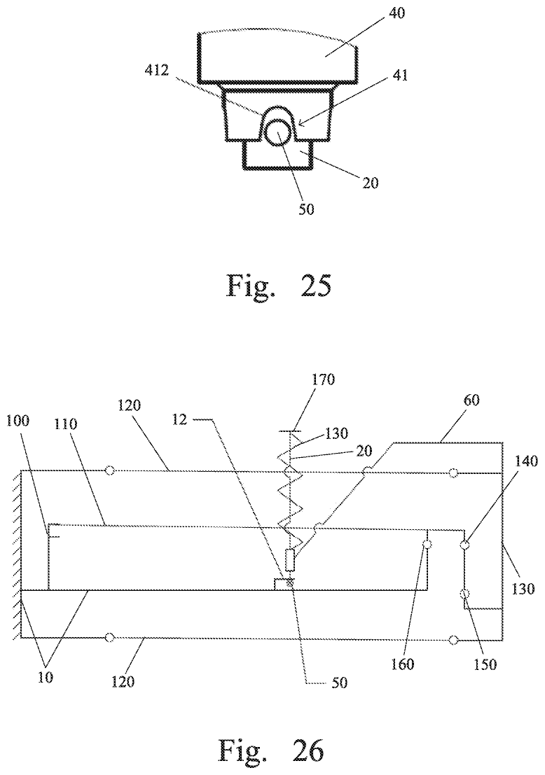

As shown in FIGS. 19 to 26, the load cell 1 having a transport anti-drop mechanism is in a transport protection state, hereinafter referred to as state 3. In state 2, after the limit pin 50 is rotated by a certain angle (shown in FIGS. 19 and 20, illustrating a 90-degree rotation), and then the load on the weighing pan connector 170 is removed to obtain state 3 in FIG. 21.

That is, this state is achieved by the core shaft 20 and the limit pin 50 being rotated by a certain angle (90 degrees as shown) after in state 2 the limit pin 50 is disengaged from the first U-shaped notches 411 on the sleeve 40.

In this case, the upper end of the limit pin 50 comes into contact with the limit baffle 12 to limit the upward movement of the weighing pan connector 170, the core shaft 20 and the limit pin 50, and applies a downward force to the weighing pan connector 170. This force is transferred through the mechanism to rotate the lever 110 to press against the upper end of the lever limit notch 100.

In state 3, in contrast to state 1, the lifting lug 130, the weighing pan support 60, the elastic body 30, the core shaft 20, the sleeve 40 and the weighing pan connector 170 will not move freely, thus avoiding collision impact. It is possible to improve the drop impact resistance during the transport. In addition, the force applied to the delicate parts, such as the upper connection joint 140, the lower connection joint 150 and the flexible joint 160, is controlled by the amount of compression of the elastic body and will not exceed their yield strength.

In the state shown in FIGS. 19 and 20, after the load on the weighing pan connector 170 is removed, the state 3 shown in FIGS. 21 to 26, i.e., the transport protection state, is obtained. The limit pin 50 comes into contact with the limit baffle 12 on the base 10 to limit the upward movement of the limit pin 50. The limit pin 50 is in the second U-shaped notches 412 of the sleeve 40, with the upper end of the limit pin 50 not in contact with the second U-shaped notches 412, so that only the left and right rotation of the limit pin 50 and the core shaft 20 is limited. FIG. 24, “M” shows position of the limit pin 50 with respect to second U-shaped notches 412 of the sleeve 40.

A first rotation baffle 13 is provided on the base 10 to limit the rotation angle of the core shaft 20 when rotated when the load cell 1 is switched from state 2 into state 3, so as to ensure that the limit pin 50 moves into the second U-shaped notches 412 of the sleeve 40 after the load on the weighing pan connector 170 is removed. Similarly, when the load cell 1 is switched from state 3 to state 1, a second rotation baffle 14 is provided to ensure that the limit pin 50 can move into the first U-shaped notches 411 after the core shaft 20 is rotated.

During transport, switching the load cell 1 in the electronic balance 2 to state 3 can effectively improve the drop impact resistance to ensure that the load cell 1 is less prone to damage during transport. After transport, the load cell 1 is switched to state 1, the electronic balance 2 and the load cell 1 can work normally. In addition, in the case of overload weighing, the load cell 1 is switched to state 2 to be under overload protection.

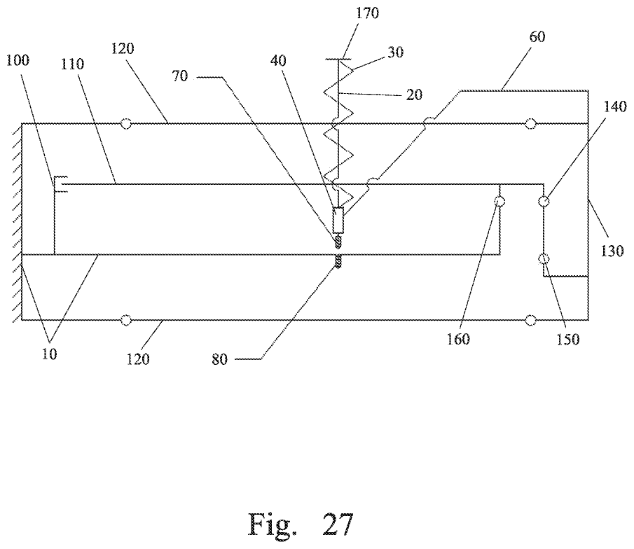

As shown in FIG. 27, the second embodiment of the present invention further provides a load cell 1 having a transport anti-drop mechanism, the load cell 1 comprising a base 10, a core shaft 20, an elastic body 30, a sleeve 40, a weighing pan support 60, and a weighing pan support 170. The base 10 is provided with a mounting recess 11, the weighing pan support 60 is provided with a through hole 61, and a sleeve 40 passes through the through hole 61 and extends into the mounting recess 11.

The core shaft 20 is arranged in the sleeve 40 in a penetrating manner, the elastic body 30 is mounted between the core shaft 20 and the sleeve 40, a shaft end of the core shaft 20 is provided with an externally threaded connecting member 70, and the bottom of the mounting recess 11 is provided with an internally threaded hole 80. The core shaft 20 is fixedly connected to the base 10 through the fitting between the externally threaded connecting member 70 and the internally threaded hole 80, and the elastic body 30 applies a fixed load to a moving part of the load cell 1 to fix the position of the moving part. The load cell 1 is in a transport protection state.

In the load cell 1 having a transport anti-drop mechanism, the shaft end of the core shaft 20 is additionally provided with the externally threaded connecting member 70, and the base 10 is additionally provided with the internally threaded hole 80. During transport, the externally threaded connecting member 70 may be screwed into the internally threaded hole 80. Since threads can be self-locking and will not be automatically disengaged after being screwed, the lifting lug 130, the weighing pan support 60, the elastic body 30, the core shaft 20, the sleeve 40 and the weighing pan connector 170 can be fixed, thus providing protection during transport. Moreover, the amount of compression of the elastic body can be adjusted by means of controlling the screwing depth of the threads, so as to achieve the benefits of selecting different compression forces to adapt to different transport conditions.

The present invention further provides an electronic balance 2, which comprises the load cell 1 having a transport anti-drop mechanism as described above.

According to the above structural description, the load cell 1 having a transport anti-drop mechanism according to the present invention have following improvements I. The overload protection and transport protection structures of the load cell 1 are combined together.

II. The elastic body 30 applies, to the moving part, a compression force that is not greater than an overload force of a weighing system and is ensured by an elastic body 30, so that the force is controllable and will not damage the sensitive parts.

III. With the structure of the elastic body 30 and the threads, the force can be adjusted to adapt to different transport environments.

In conclusion, in the load cell 1 having a transport anti-drop mechanism and the electronic balance 2 comprising the load cell 1 according to the present invention, a structure for improving the impact resistance of the magnetic force restoration load cell 1 is designed to allow the load cell 1 to be switched between the non-transport protection state, the overload protection state and the transport protection state, and the load that exceeds the compression force of the elastic body 30 can be directly transferred to the base, thereby protecting the delicate parts against collision impact.

Such a structure can improve the drop impact resistance during transport, and the force applied to the delicate parts is controlled by the amount of compression of the elastic body and it will not exceed the yield strength of the delicate parts.

Although specific implementations of the present invention have been described above, those skilled in the art should understand that these are merely examples, and the scope of protection of the present invention is defined by the appended claims. Various alterations or modifications to these implementations can be made by those skilled in the art without departing from the principle and essence of the present invention. However, these alterations and modifications all fall within the scope of protection of the present invention.

### REFERENCE SIGNS LIST

Load cell 1
Electronic Balance 2
Base 10
mounting recess 11
limit baffle 12
first rotation baffle 13
second rotation baffle 14
Core Shaft 20
Elastic body 30
Sleeve 40
limit notches 41
Limit pin 50
weighing pan support 60
through hole 61
externally threaded connecting member 70
internally threaded hole 80
lever limit notch 100
Lever 110
parallel guide sheet 120
lifting lug 130
upper connection joint 140
lower connection joint 150
flexible joint 160
weighing pan connector 170
first U-shaped notches 411
second U-shaped notches 412

1. A load cell having a transport anti-drop mechanism comprising:
a base;
a core shaft;
an elastic body;
a sleeve;
a limit pin;
a weighing pan support;
a weighing pan connector, wherein the base is provided with a mounting recess, the weighing pan support is provided with a through hole, and the sleeve passes through the through hole and extends into the mounting recess, and
wherein the core shaft is arranged in the sleeve in a penetrating manner, the elastic body is mounted between the core shaft and the sleeve, the weighing pan connector is mounted at an end portion of the core shaft, the limit pin is mounted at the end of the core shaft and located outside the sleeve, the end of the sleeve is provided with a plurality of limit notches; and
a limit baffle provided on an inner wall surface of the mounting recess for limiting the position of upward movement of the limit pin;
wherein the load cell is capable of switching between a non-transport protection state, an overload protection state and a transport protection state through the fitting between the limit pin, the corresponding limit notch and the limit baffle.

2. The load cell having a transport anti-drop mechanism according to claim 1, wherein:
the load cell comprises a moving part having predetermined position;
when the weighing pan connector receives a downward force that exceeds a pre-compression force of the elastic body, the load cell is in an overload protection state;
the limit pin moves downwards and is disengaged from the corresponding limit notch and comes in contact with the base, and the base bears the load that exceeds the compression force of the elastic body, so that the position of the moving part of the load cell is fixed.

3. The load cell having a transport anti-drop mechanism according to claim 1, wherein:
when the load cell is in a transport protection state, the limit pin comes into contact with the limit baffle to limit the position of the limit pin to allow the limit pin to enter the corresponding limit notch, and the elastic body applies a fixed load to the moving part of the load cell to fix the position of the moving part.

4. The load cell having a transport anti-drop mechanism according to claim 2, wherein:
the moving part comprises delicate parts including the lever, the upper connection joint, the lower connection joint and the flexible joint.

5. The load cell having a transport anti-drop mechanism according to claim 1, wherein:
the limit baffle horizontally extends outwards along the inner wall surface of the mounting recess and is located above the limit pin.

6. The load cell having a transport anti-drop mechanism according to claim 1, wherein:
the limit notch is a U-shaped notch.

7. The load cell having a transport anti-drop mechanism according to claim 6, wherein:
the end of the sleeve is provided with four symmetrically distributed U-shaped notches.

8. The load cell having a transport anti-drop mechanism according to claim 7, wherein:
the U-shaped notches include at least one pair of first U-shaped notches and at least one pair of second U-shaped notches arranged opposite each other;
when the moving part of the load cell is movable, the limit pin is located in the first U-shaped notches and has a distance from the base; and
when the load cell is in a transport protection state, the limit pin is located in the second U-shaped notches, and the limit pin has a distance from the bottom of the second U-shaped notches.

9. The load cell having a transport anti-drop mechanism according to claim 1, wherein:
a first rotation baffle is further provided on the inner wall surface of the mounting recess for limiting the rotation angle of the core shaft when the load cell is switched from the overload protection state to the transport protection state.

10. The load cell having a transport anti-drop mechanism according to claim 9, wherein:
a second rotation baffle is further provided on the inner wall surface of the mounting recess for limiting the rotation angle of the core shaft when the load cell is switched from the transport protection state to the non-transport protection state.

11. The load cell having a transport anti-drop mechanism according to claim 10, wherein:
the first rotation baffle and the second rotation baffle are vertically connected below the limit baffle.

12. A load cell having a transport anti-drop mechanism, the load cell comprising:
a base;
a core shaft;
an elastic body;
a sleeve; and
a weighing pan, support wherein the base is provided with a mounting recess, the weighing pan support is provided with a through hole, and the sleeve passes through the through hole and extends into the mounting recess;
wherein the core shaft is arranged in the sleeve in a penetrating manner, the elastic body is mounted between the core shaft and the sleeve, a shaft end of the core shaft is provided with an externally threaded connecting member, and the bottom of the mounting recess is provided with an internally threaded hole; and
wherein the core shaft is fixedly connected to the base by means of the fitting between the externally threaded connecting member and the internally threaded hole, and the elastic body applies a fixed load to a moving part of the load cell to fix the position of the moving part.

13. An electronic balance, comprising the load cell of claim 1.

14. An electronic balance, comprising the load cell of claim 12.
